(19) United States
(12) Patent Application Publication
(10) Pub. No.: US 2008/0290547 A1
(43) Pub. Date: Nov. 27, 2008

(54) Methods of forming muffler preforms

(76) Inventors: Sanjay P. Kashikar, Kelmis (BE); Luc J. L. Brandt, Henri-Chapelle (BE); Leon Charlier, Battice (BE)

Correspondence Address: OWENS CORNING, 2790 COLUMBUS ROAD, GRANVILLE, OH, 43023, US

(21) Appl. No.: 11/807,053

(22) Filed: May 25, 2007

(51) Int. Cl. B29C 59/02

(52) U.S. Cl. 264/119; 65/450

(57) ABSTRACT

Methods of forming compressed preform products formed from continuous fibers substantially evenly coated with a thermoplastic sizing composition are provided. Applying a thermoplastic sizing composition to continuous fibers during the formation of the fibers enables a preform to be formed without applying any additional sizing or binder compositions at later stages of the manufacturing of the preform. The thermoplastic sizing composition includes a thermoplastic material, and, optionally a silane coupling agent. The thermoplastic material in the thermoplastic sizing composition includes chemicals and/or compounds that are thermoplastic or possess thermoplastic properties. One or more preforms may be randomly inserted to a muffler cavity. Upon the application of heat, the preforms decompress and fill the cavity with fibrous material. Due to the ability to decompress the compressed preform product, the preform product can have a shape that is independent of the shape of the muffler cavity.

### TECHNICAL FIELD AND INDUSTRIAL APPLICABILITY OF THE INVENTION

The present invention relates generally to preforms, and more particularly, to methods of forming highly compacted glass fiber preforms directly from texturized or non-texturized continuous glass fibers coated with a thermoplastic sizing composition. The glass fiber preforms may be decompressed under heat within the internal cavity of a muffler to restore the glass fibers to an uncompressed form, thereby filling or substantially filling the muffler cavity to provide good sound attenuation.

### BACKGROUND OF THE INVENTION

Acoustical sound insulators are used in a variety of settings where it is desired to reduce noise emissions by dissipating or absorbing sound. For example, it is known in the art to use a sound absorbing material in exhaust mufflers for internal combustion engines to dampen or attenuate sound made by the engine exhaust gases as they pass from the engine through the exhaust system and into the atmosphere. Typically, continuous glass fiber strands are positioned internally in a muffler as the sound absorbing material. Continuous glass fibers are preferred over other fibers, such as chopped glass fibers, because the length of the continuous fibers decreases the possibility that free fibers may dislodge from the muffler and exit into the atmosphere.

Continuous glass fiber strands may be positioned in a muffler by a variety of methods known in the art. For example, continuous glass fiber strands may be inserted directly into a muffler shell, such as is disclosed in U.S. Pat. No. 4,569,471 to Ingemansson et al. In particular, Ingemansson et al. disclose a process and apparatus for filling muffler shells by feeding continuous multifilament glass fiber strands through a nozzle and into a muffler outer shell. Compressed air is used expand the fiber strands into a wool-like material inside the shell.

Alternatively, fibrous filed bags may be utilized to fill the inner cavities of a muffler. U.S. Pat. No. 6,607,052 to Brandt et al. discloses a process for filling a muffler shell with continuous glass fiber strands in which a bag is filled with continuous glass fibers and inserted into a muffler cavity. The bag has a first side with one or more first perforations defining: a first side total open area and a second side with either no perforations or one or more second perforations defining a second side total open area. The first side total open area is greater than the second side total open area. The bag is filled with a fibrous material (e.g., continuous glass fiber strands) and positioned adjacent to an internal structure located within a first muffler shell part. A partial vacuum is applied to draw the filled bag towards the internal structure. A second muffler shell part is then placed adjacent to the first muffler shell part such that the first and second muffler shell parts define an internal cavity containing the internal structure and the fibrous material-filled bag.

In addition to filling a muffler shell with continuous glass fiber strands, it is also known in the art to form preforms of continuous glass fiber strands which are adapted to be inserted into a muffler shell. U.S. Pat. No. 5,766,541 and EP 0 941 441 to Knutsson et al. discloses a preform of continuous glass fiber strands made by feeding continuous glass fiber strands into a perforated mold to form a continuous wool product in the mold, feeding a binder into the mold, compressing the mold to compact the wool product to a desired density, heating the mold to cure the binder, and removing the preform from the mold. The preform may then be inserted into a muffler cavity.

In U.S. Patent Publication No. 2001/0011780 A1 and EP 0 692 616 to Knutsson, continuous glass fiber strands and a powder binder are blown into a cavity formed of a perforated screen having the shape of the muffler to be filled. Hot air is then passed through the perforated screen to melt the binder and bond the fibers together. Next, cool air is circulated through the screen to cool the preform so that it can be removed from the screen and inserted into a muffler.

In many of the methods in existence for forming muffler preforms, a binder is applied to the fibers prior to filling a muffler mold with the fibers. Generally, the binder is sprayed onto the glass fibers during the texturization of the fibers to form a wool-like material. The binder conventionally used in muffler preforms is a thermosetting, phenolic-based resin. The phenolic-based resin is in a powder form and is sprayed onto the fibers with water as a slurry. After curing, thermosetting binders generally form crosslinked products through irreversible cross-linking reactions. Thus, once the binder in contact with the fibers is cured, such as in an oven, the cured binder holds or retains the fibers in the shape of the preform until the preform is installed into a muffler shell. After the preform is installed in the muffler shell, the binder is no longer needed, and is typically burned off by running the vehicle for a period of time sufficient to remove at least a substantial portion of the binder from the preform.

Phenolic-based binders such as are used in continuous glass fiber strand preforms for mufflers have many undesirable characteristics. For example, spraying the slurry containing the powder binder can lead to an uneven distribution of the binder on the glass fibers. As a result, a handleable and usable preform is possible only when there is binder present at fiber-to-fiber contact points. In order to achieve a stable and homogenous product, larger amounts of binder may be needed. In addition, the application of the phenolic binder creates environmental and safety issues because the application into the preform mold is not always accurate, and a portion of the phenolic-based binder may be deposited outside the preform mold and onto the apparatus and/or floor. Additionally, because the thermosetting phenolic-based binder exists in a solid form and possesses high softening points, high temperatures are required to place the binder in a molten state so that the binder may then be cured. Further, long cycle times are needed to complete the heat-cure-cool cycle to fully cure the binder because entire preform must be heated to the appropriate binder cure temperature and be held at that high temperature for the entire cure time. Such an extended cure time results in increased production cycle time and increased cost. Additionally, the decomposition of the phenolic-based binder during burn-off releases noxious gases and undesirable odors. Utilizing a phenolic-based binder also requires a more expensive and complicated spraying and/or texturizing gun because the gun needs to handle both the solid powder chemical and water that is sprayed onto the fibers during the fiber texturization. Additionally, separate binder handling and delivery equipment is required on the floor, thus adding to the complexity of the current processes.

Thus, there exists a need in the art for an alternative binder composition and a simple, compact process to form a muffler preform that is environmentally friendly and which effectively reduces the costs associated with phenolic powder binders and processes currently used to make muffler preforms.

### SUMMARY OF THE INVENTION

It is an object of the present invention to provide a method of making a compressed preform product that includes (1) filling a mold cavity with continuous heat resistant fibers at least partially coated with a thermoplastic sizing composition, (2) compressing the coated fibers, (3) heating the compressed preform product to a temperature sufficient to at least partially melt the thermoplastic material on the continuous fibers, and (4) cooling the compressed preform product to solidify the thermoplastic material on the continuous fibers to form a compressed preform product having a predetermined shape. The thermoplastic sizing composition includes a thermoplastic material, and, optionally a silane coupling agent. In one exemplary embodiment, the thermoplastic sizing composition is applied to the glass fibers during fiber formation. When the thermoplastic sizing composition is applied onto the glass fibers under a bushing, no additional step of applying a separate sizing or binder composition at later stages of the formation of the preform is necessary. In addition, thermoplastic material may be permitted to cool and solidify naturally onto the glass fibers. In an alternate embodiment, an aqueous sizing composition is applied to the fibers as they are attenuated from the bushing and a thermoplastic material (e.g., a thermoplastic binder) is applied to the sized fibers during the texturization of the fiber strand. Thus, the sizing composition is positioned between the continuous fiber and the thermoplastic binder composition. Heating the compressed preform product may be achieved by any heat source, such as, but not limited to, a gas heater, hot air, a radio frequency apparatus, an ultrasonic energy apparatus, and a heat resistor. The heat from the heat source is evenly and efficiently passed through the perforated plates at opposing ends of a mold cavity by suction created in a vacuum box. As a result, it is not necessary for the heat source to physically blow or force the heat or hot air into and through the compressed preform product. To cool the compressed preform, ambient air is passed through the compressed preform via suction created through the vacuum box. The cooled, compressed preform may be removed by turning off the vacuum box and permitting the compressed preform product to fall.

It is another object of the present invention to provide a method of making a fiber product for forming a preform that includes (1) attenuating molten glass from a bushing to form glass fibers, (2) applying a thermoplastic sizing composition containing a thermoplastic material on the glass fibers under the bushing, where the thermoplastic sizing composition substantially coating the glass fibers, and (3) cooling the thermoplastic material to solidify the thermoplastic material on the glass fibers to form a fiber preform product. The fiber product is capable of forming a stable preform without applying any additional sizing or binder compositions at later stages of the formation of the preform. Optionally, the thermoplastic sizing composition contains a silane coupling agent. The thermoplastic material in the thermoplastic sizing composition includes chemicals and/or compounds that are thermoplastic and/or chemicals and/or compounds that possess thermoplastic properties. The thermoplastic size composition may be applied by conventional methods such as by an application or by spraying the size directly onto the fibers to achieve a desired amount of the sizing composition on the fibers. Desirably, the application method applies a substantially even coating of the thermoplastic sizing composition onto the glass fibers. The thermoplastic sizing on the continuous fibers may be allowed to cool and solidify naturally and then be wound into a single end direct roving package.

It is a further object of the present invention to provide a method of filling a muffler shell that includes (1) filling a mold cavity with continuous, texturized continuous fibers at least partially coated with a thermoplastic sizing composition including a thermoplastic material, (2) compressing the coated fibers within the mold cavity to form a compressed preform product, (3) heating the compressed preform product to a temperature sufficient to at least partially melt the thermoplastic material on the continuous fibers, (4) cooling the compressed preform product to solidify the thermoplastic material on the continuous fibers to form a compressed preform, (5) depositing one or more compressed preforms into the muffler cavity, and (6) decompressing the compressed preform by heating the muffler to a temperature sufficient to at least partially melt the thermoplastic material to reinstate the continuous, texturized continuous fibers to a decompressed form and fill the muffler cavity. Optionally, the thermoplastic sizing composition contains a silane coupling agent. The compressed preform may have a shape independent of a shape of a muffler cavity or a shape that is substantially similar to the shape of the muffler into which it is to be inserted. The compressed preform provides for reduced complexity in the designing the preform shape. Heating the thermoplastic material on the fibers melts and releases the fibers from their compressed or strained form. This reversible nature of the compressed preform eliminates the need for a preform that has the precise and often complex dimensions of the muffler into which it is to be inserted. In addition, because the preform(s) inserted into the muffler are in a compressed form, there is little or no interference with the welding joints or overlap of the glass fibers outside of the muffler cavity.

It is an advantage of the present invention that the thermoplastic size composition is non-corrosive in nature, and, as a result, enhances the lifetime of the mold as well as the lifetime of the muffler.

It is yet another advantage of the present invention that the preform products are recyclable in that the texturized glass fibers from a non-usable preform can be re-molded and re-compressed into a compressed preform product.

It is an additional advantage of the present invention that the thermoplastic sizing composition enables the formation of the preform without the application of any additional sizing or binder compositions at later stages of the formation of the preform.

It is a further advantage of the present invention that because of the lack of additional chemicals in the inventive processes, the inventive methods are clean, dry, and environmentally friendly.

It is yet another advantage of the present invention that previously texturized fibers can be used to produce compressed preform products having any desired shape.

It is also an advantage of the present invention that the recycleability of the texturized glass fibers results in minimal or zero waste.

It is a feature of the present invention that an appropriate amount of glass is utilized in the compressed preform product to achieve optimum sound absorption, and the overall part weight is lowered.

It is another feature of the present invention that the compressed preform product is not required to have the exact or similar shape of the muffler cavity into which it is to be inserted.

It is yet another feature of the present invention that the preform product decompresses upon the application of heat.

It is a further feature of the present invention that in one exemplary embodiment, the thermoplastic binder is substantially even distributed on the continuous fibers as they are attenuated from the bushing.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of the formation of continuous glass strands coated with a thermoplastic sizing material for use in the present invention;

FIG. 2 is a flow diagram illustrating the steps for forming a preform according to an exemplary embodiment of the present invention;

FIG. 3 is a schematic illustration of introducing the nozzle into the mold cavity according to the present invention;

FIG. 4 is a schematic illustration of filling the mold cavity with texturized glass fibers according to the present invention;

FIG. 5 is a schematic illustration of a mold cavity filled with texturized glass fibers according to the present invention;

FIG. 6 is a schematic illustration of the compression of the texturized glass fibers according to the present invention;

FIG. 7 is a schematic illustration of heating the compressed disc of glass fibers according to the present invention;

FIG. 8 is a schematic illustration of cooling the compressed disc of glass fibers according to the present invention;

FIG. 9 is a schematic illustration of removing the compressed disc from the mold;

FIG. 10 is a schematic illustration of introducing the nozzle into the mold cavity according a second embodiment of the present invention;

FIG. 11 is a schematic illustration of filling the mold cavity with texturized glass fibers according a second embodiment of the present invention;

FIG. 12 is a schematic illustration of a mold cavity filled with texturized glass fibers according to a second embodiment of the present invention;

FIG. 13 is a photographic illustration of a compressed preform product according to at least one exemplary embodiment of the present invention;

FIG. 14 is a photographic illustration of the preform product depicted in FIG. 13 after heating in an oven for one minute at 80° C.; and

FIG. 15 is a photographic illustration of the preform product depicted in FIG. 13 after heating in an oven for three minutes at 80° C.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. It will be understood that when an element is referred to as being “on,” another element, it can be directly on or against the other element or intervening elements may be present. The terms “thermoplastic sizing”, “thermoplastic sizing composition” and “thermoplastic size” may be used interchangeably herein. In addition, the terms “size”, “sizing”. “size composition” and “size formulation” may be used interchangeably herein.

The present invention relates to preforms formed from continuous fibers that are substantially evenly coated with a thermoplastic sizing composition and a method of forming the preforms. The thermoplastic sizing composition enables the formation of the preform without the application of any additional sizing or binder compositions at later stages of the formation of the preform. The thermoplastic sizing composition may be used in an aqueous or non-aqueous phase, but is preferably non-aqueous in nature. The non-aqueous thermoplastic sizing composition may be characterized by the substantial non-aqueous nature or state of the ingredients during their use and application onto the fibers.

The thermoplastic sizing composition includes a thermoplastic material, and, optionally a silane coupling agent. The thermoplastic material in the thermoplastic sizing composition includes chemicals and/or compounds that are thermoplastic and/or chemicals and/or compounds that possess thermoplastic properties (e.g., the ability to undergo numerous heat and cool cycles and are thus “reversible” in nature). Other specific additives needed during fiber manufacturing and/or post-processing of the continuous fibers may also be included in the thermoplastic sizing composition. The thermoplastic sizing composition includes a thermoplastic material or a combination of thermoplastic materials. It is desirable that the thermoplastic material is capable of melting or having a lowered viscosity upon the application of energy and a higher viscosity or the ability to solidify naturally upon aided or unaided cooling. In addition, the thermoplastic sizing composition is desirably in a solidified form at room temperature.

The thermoplastic material may include chemicals or compounds capable of undergoing one or several heat cycles (i.e., melt and flow) and cool cycles (i.e., solidification). In addition, the thermoplastic materials may be based on synthetic or natural chemicals, polymers, oligomers, and/or waxes, including their modified structures or forms, and which may be ionic, non-ionic, or amphoteric in nature. The thermoplastic material is not particularly limited, and includes thermoplastic materials such as, but not limited, to polymers and/or modified polymers such those as based on polypropylene, polyester, polyamide, polyethylene, polyethylene oxide (PEO), polyacryl amide, polyacrylic acid, polyethylene terephthalate (PET), polyphenylene sulfide (PPS), polyphenylene ether (PPE), polyetheretherketone (PEEK), polyetherimides (PEI), polyvinyl chloride (PVC), ethylene vinyl acetate/vinyl chloride (EVA/VC), lower alkyl acrylate polymers, acrylonitrile polymers, partially hydrolyzed polyvinyl acetate, polyvinyl alcohol, polyvinyl pyrrolidone, styrene acrylate, polyolefins, polyamides, polysulfides, polycarbonates, rayon, nylon, phenolic resins, and epoxy resins; oxidized thermoplastics; functional thermoplastics; modified thermoplastics; waxes or waxy substances such as Vybar 103 , Vybar 260 , Vybar 825 (available from Baker Petrolite), and Polyboost 130 (available from S&S Chemicals); crystalline or semi-crystalline materials or waxes, microwaxes, microcrystalline waxes, silicones, modified silicones; surfactants, ethoxylated fatty alcohol ethers, ethoxylated fatty acid esters; modified fatty acid esters, modified fatty alcohol ethers, glycerol, modified glycerol, lubricants (stearates, metal stearates, ethylene bis-stearamide, and mono-stearamide); wetting agents; and combinations thereof.

The thermoplastic sizing composition may also optionally contain a silane coupling agent in a partially or a fully hydrolyzed state or in a non-hydrolyzed state. The silane coupling agents may also be in monomeric, oligomeric or polymeric form prior to, during, or after their use. The silane is preferably an organosilane. Non-limiting examples of silane coupling agents which may be used in the present size composition may be: characterized by the functional groups amino, epoxy, vinyl, methacryloxy, ureido, isocyanato, and azamrido. Suitable silane coupling agents that may be used in the thermoplastic size composition include aminosilanes, silane esters, vinyl silanes, methacryloxy silanes, epoxy silanes, sulfur silanes, ureido silanes, isocyanato silanes, fatty or long alkyl chain trialkoxysilanes (e.g., octyltrialkoxysilane, hexadecyltrialkoxysilane, and octadecyltrialkoxysilane), polymer chain trialkoxysilanes, polyethyleneglycol trialkoxysilane, polyethyleneoxide trialkoxysilane, polyether trialkoxysilane, and azido silanes.

If the thermoplastic sizing composition is in an aqueous phase, water may be included in an amount sufficient to dilute the thermoplastic sizing composition to a viscosity that is suitable for its application to glass fibers. In particular, the thermoplastic sizing composition may contain up to about 99% water, but preferable contains from about 40 to about 95% water. The fibers may then be dried for further use.

Additives may be included in the thermoplastic sizing composition to impose desired properties or characteristics to the composition and/or the final product. Non-exclusive examples of additives for use in the thermoplastic sizing composition include pH adjusting agents, chain flexibilizers, UV stabilizers, antioxidents, acid- or base-capturers, metal deactivators, processing aids, oils, lubricants, antifoaming agents, antistatic agents, thickening agents, adhesion promoters, compatabilizers, stabilizers, flame retardants, impact modifiers, pigments, dyes, colorants, masking fluids, and/or odors or fragrances.

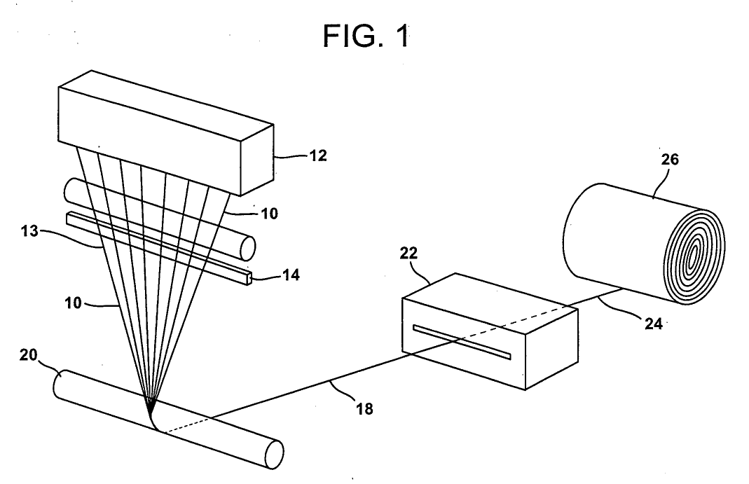

In one exemplary embodiment, the thermoplastic sizing composition is applied to glass fibers during fiber formation. It is also to be appreciated that the methods described herein are made with reference to glass fibers for illustrative purposes, and that any continuous fiber capable of withstanding heat may be used in accordance with the present invention. For example, as shown in FIG. 1, glass fibers 10 may be formed by attenuating streams of a molten glass material (not shown) from a bushing 12. The attenuated glass fibers 10 may have diameters as small as 6 microns. In some exemplary embodiments, the glass fibers 10 may have a diameter of more than 32 microns. Preferably, the fibers have a diameter from about 6 microns to about 32 microns, and more preferably from about 9 microns to about 28 microns. After the glass fibers 10 are drawn from the bushing 12, a thermoplastic size composition is applied to the fibers 10. The thermoplastic size composition may be applied by conventional methods such as by the application roller 14 shown in FIG. 1 or by spraying the size directly onto the fibers (not shown) to achieve a desired amount of the sizing composition on the fibers 10. Other binder application methods known in the art such as kiss roll, dip-draw, or slide may alternatively be utilized.

When the thermoplastic sizing composition is applied onto the glass fibers 10 under the bushing, no additional step of applying a separate sizing composition, such as is described with respect to the alternate embodiment below, is needed. When the inventive thermoplastic sizing is in a non-aqueous form, the thermoplastic sizing composition is used in a molten form to lower the viscosity, to improve the flow, to improve the wetting on the fiber surface, and to allow a homogeneous or substantially homogenous application of the thermoplastic sizing composition on the fibers along their length during their manufacture.

Desirably, the application method applies a substantially even coating of the thermoplastic sizing composition onto the glass fibers 10. As used herein, the phrase “substantially even coating” is meant to indicate that the fibers 10 are evenly coated or nearly evenly coated with the thermoplastic sizing. The thermoplastic size composition may be applied to the fibers 12 with a Loss on Ignition (LOD) from approximately 0.5 to about 30% or more on the dried fiber, preferably between about 2 to about 10%, and most preferably from about 3 to about 7%. LOI may be defined as the percentage of organic solid matter deposited on the glass fiber surfaces.

After the glass fibers 10 are treated with the thermoplastic sizing composition, the coated glass fibers 10 are gathered into a strand 18 by a gathering shoe 20. When the thermoplastic sizing composition is in a non-aqueous and molten form, the strand 18 may be cooled by a cooling apparatus 22 (e.g., a water bath) to solidify the thermoplastic sizing composition onto the glass fibers 10. The coated fibers 10 may also (or alternatively) be air cooled and/or air-dried. If the coated fibers 10 are permitted to air dry or solidify, no further drying is needed. The thermoplastic sizing may also be allowed to cool and solidify naturally and wound into a single end direct roving package. On the other hand, if the thermoplastic sizing composition is an aqueous form, the strand 18 may be passed through or by a heating element such as a conventional oven and/or radio frequency drying equipment (not illustrated) to remove excess water, either partially or completely. Once the excess water is removed, the thermoplastic material is allowed to cool and solidify onto the glass fibers 10. After the thermoplastic material is solidified onto the glass fiber 10, the continuous, dried strand 24 is then gathered onto a creel to form a roving or package 26. Alternatively, the strand 18 may be wound into a package 26 during the fiber manufacturing or fiber formation process and then passed through an oven or other drying apparatus to remove excess water so that the fibers 24 having the thermoplastic sizing thereon are ready to be used to form preforms.

The glass utilized to form the continuous strand may be any type of glass suitable to withstand high temperatures, such as those emanating from engine exhaust. Preferred types of glass fibers include E-type glass fibers, S-type glass fibers, Hiper-tex™, and Advantex® glass fibers. It is contemplated that other types of heat resistant continuous fibers such as carbon fibers, mineral fibers, mineral wool, and rock wool (i.e., continuous basalt fibers) and synthetic fibers such as polyamide, aramid, and/or polyaramid may be utilized and/or commingled with the glass fibers to form the preform product. Glass fibers are preferred for use in mufflers because of their sound attenuation capability and resistance to the extreme heat conditions, such as those produced within a muffler. Because a thermoplastic sizing composition is applied to the glass fibers, the inventive method may be performed without the addition of, or commingling with, any other fibers or fibrous materials including any other types of glass fibers or synthetic and/or thermoplastic fibers. However, the addition of inorganic glass of different types and/or thermoplastic fibers such as polyester, polyethylene, polyethylene terephthalate, polypropylene, polyamide is not excluded from the realm of the present invention.

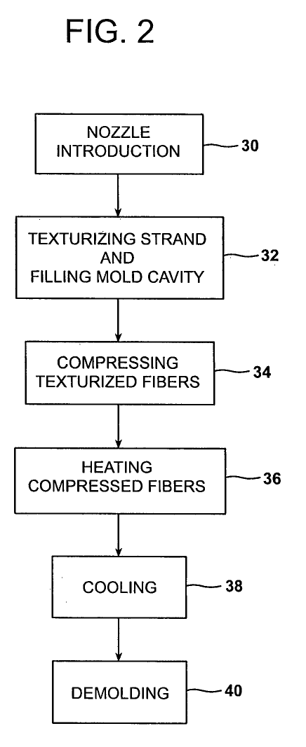

One exemplary method for forming the inventive preforms includes introducing a nozzle into the mold cavity (30), texturizing a glass strand and filling a mold cavity (32),. compressing the texturized fibers (34), heating the compressed, texturized fibers (36), cooling the compressed, texturized fibers (38), and demolding (40), as is depicted in FIG. 2. It is to be appreciated that the method described herein is for illustrative purposes only, and preform parts of various forms, shapes, sizes, designs, dimensions, geometries, and densities may be formed by other methods utilizing the fibers sized with the thermoplastic sizing composition described herein.

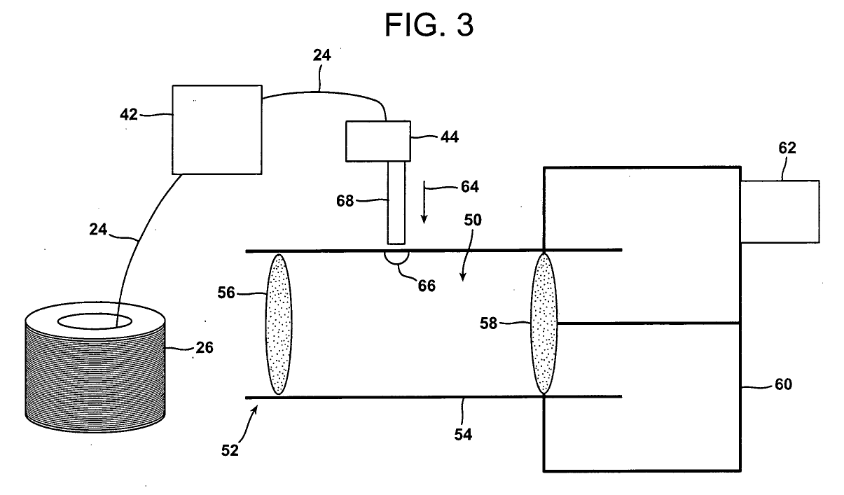

One exemplary method of forming a preform product according to the present invention is depicted generally in FIGS. 3-10. As shown in FIG. 3, the mold 52 is formed as a cylindrical member slidably associated with a vacuum box 60. It is to be appreciated that although a tubular structure is illustrated as the shape of the mold 52, any desired geometric form, such an elliptic or rectangular form, may be utilized so long as the geometric form permits movement of the mold 52 into and out of the vacuum box 60. The shape of the mold 52 may also have the general shape of the muffler shell into which the preform is to be inserted. The mold 52 includes a first perforated plate 56 that covers the cross-section of the mold 52. The first perforated plate 56 is fixed to the wall 54 within the mold 52 and serves as a back wall for the mold cavity 50. The vacuum box 60 is provided with a second perforated plate 58 that substantially covers the cross-section of the mold 52 with minimal air gaps to prevent the passage of glass fibers past the second perforated plate 58, yet permits the vacuum box 60 to draw a vacuum in the mold cavity 50 by the vacuum pump 62. Preferably, the perforated plates 56, 58 are perforated with a plurality of holes so that air, but not the continuous glass fibers, can pass through the plates. The first and second perforated plates 56, 58 may be formed of any suitable material such as a screen, mesh, or perforated metal with uniform or non-uniform hole sizes.

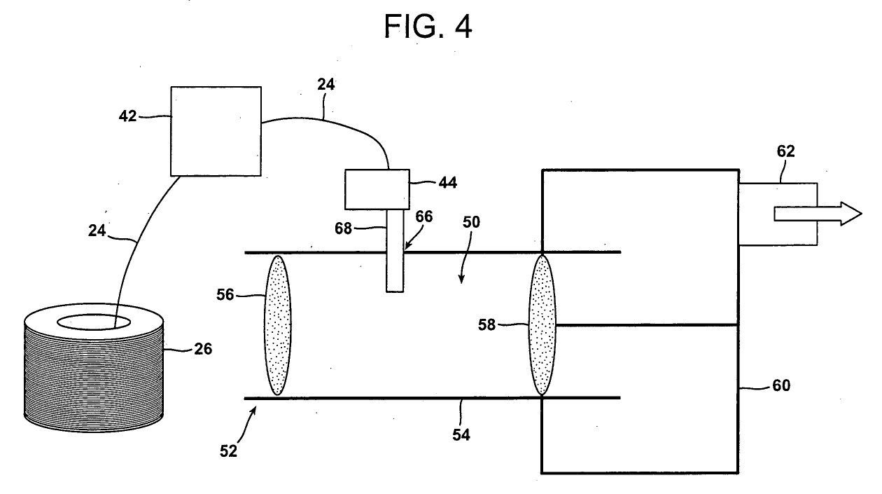

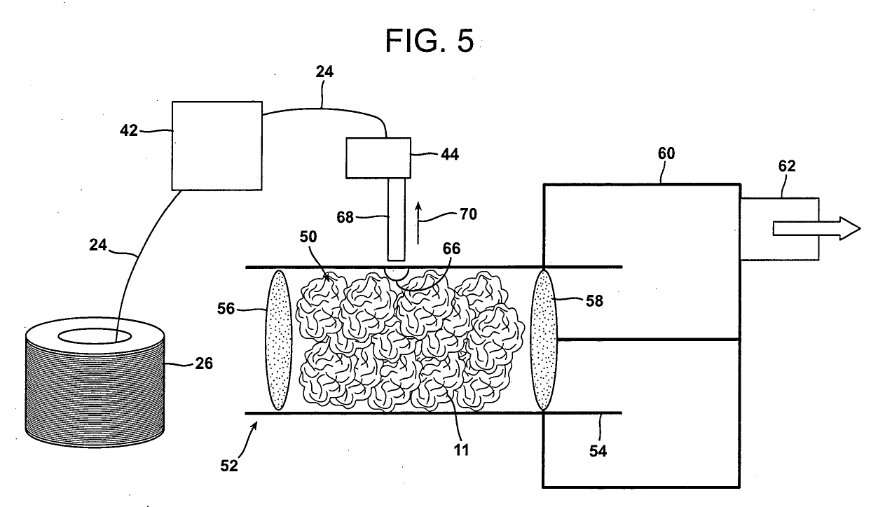

To fill the mold cavity 50 with a desired amount of glass fibers, the nozzle 44 is moved downwardly in the direction of arrow 64 until the neck 68 of the nozzle 44 is inserted into the mold cavity 50 through an opening or orifice 66 in the wall 54 of the mold 52. It is envisioned that the neck 68 may be inserted into the mold cavity 50 from any direction, such as from the sides or bottom of the mold 52. Once the neck 68 is in direct communication with the mold cavity 50 (see FIGS. 4 and 5), the roving 26 supplies the glass strands 24 to a strand feeder 42. The strand feeder 42 may include one or more strand feeding mechanisms that feed one or more continuous strands 24 of glass fibers 12 into the nozzle 42. The feeder 42 controls the speed or rate at which the continuous glass strands 24 are fed into the nozzle 44. Additionally, the strand feeder 42 dictates the amount of the continuous glass strands 24 that are inserted into the mold cavity 50 by a metering device.

The nozzle 44 blows the continuous glass strands 24 into the mold cavity 50 through the opening 66 in the walls 54 of the mold 52. Preferably, the air is pressurized by a conventional compressor and supplied by a hollow conduit in direct communication with the nozzle 44. As the continuous glass strands 24 are fed into the mold cavity 50, the expansion of the air flow into the mold cavity 50 separates the fibers forming the glass strands and entangles the individual fibers 10 to give the fibers a “fluffed-up” or wool-like appearance (i.e., texturize the glass fibers 10). It is to be noted that although the preferred embodiment described herein depicts the use of texturized glass fibers, non-texturized glass fibers may alternatively be used to form a preform product, in which case the nozzle 44 (e.g., texturizing gun) may be replaced by a simpler texturizing gun for providing the glass strands 24 into the mold cavity 50. In addition, it is within the purview of the invention to utilize pre-texturized continuous fibers and manually or automatically insert the pre-texturized fibers into the mold cavity 50. A vacuum may be applied to the mold cavity 50 in the vacuum box 60 to evenly distribute and guide or direct the continuous, texturized glass fibers 11 within the mold cavity 50 and to gather any small, broken glass fibers.

The continuous glass strands 24 are fed into the mold cavity 50 until the mold 52 has been filled with a desired quantity of glass fibers, which is the state represented by FIG. 5. A counter (not shown) may be used to measure the amount of glass strands 24 being fed into the mold cavity 50. Once the mold 52 has been filled with the desired amount of texturized glass fibers 11, the feeder 42 stops feeding the glass strands 24 to the nozzle 44. A cutting apparatus (not shown) integrated into the nozzle 44 then cuts the strands 24. The neck 68 of the nozzle 44 is removed from the mold cavity 50 by moving the nozzle 44 upwardly in the direction of arrow 70.

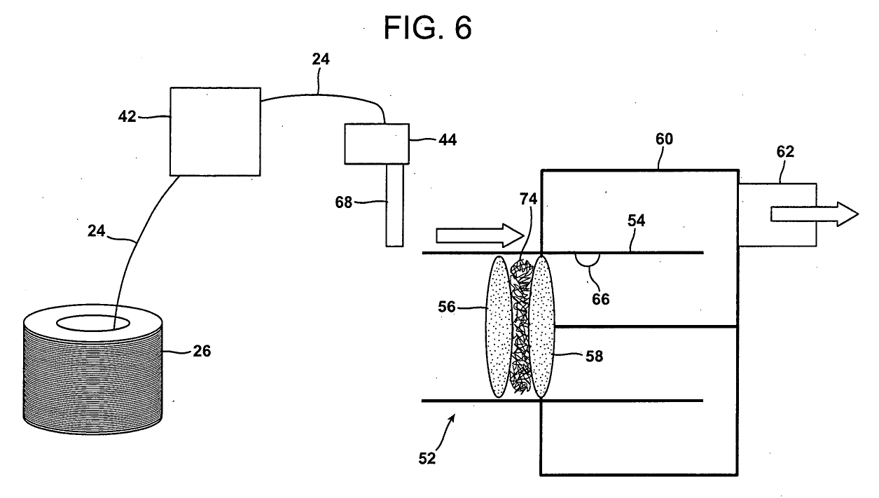

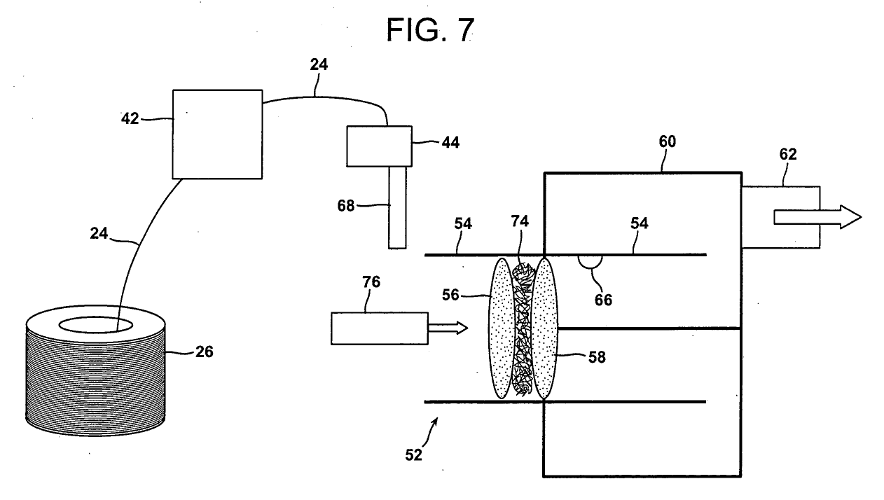

Turning to FIG. 6, the mold 52 is moved into the vacuum box 60 such that the first perforated plate 56 compresses the texturized glass fibers 11 against the second perforated plate 58 to form a compressed disc 74 of texturized glass fibers 11 between the two plates 56, 58 and such that the orifice 66 is positioned inside the vacuum box 60. It is to be appreciated that in some embodiments, the orifice 66 is not positioned inside the vacuum box 60. The mold 52 may be moved into the vacuum box 60 with the assistance of a motor and guiding equipment (not shown). An air vacuum may optionally be applied as the texturized fibers 11 are being compressed. The texturized glass fibers 11 within the mold cavity 50 may be compressed to a significantly reduced size and/or thickness compared to the original size. The disc 74 can be formed of any size and density, depending upon the volume or size of the mold cavity 50 and the amount of pressure applied to the texturized glass fibers 11 when forming the compressed disc 74. In addition, the cross-section of the disc 74 can be varied by changing the cross-section of the mold 52. As shown in FIG. 7, the compressed disc 74 is then heated to a temperature sufficient to melt or at least partially melt the thermoplastic material on the glass fibers. A heat source 76 is applied to the compressed disc 74 for a period of time sufficient to raise it to the melting temperature of the thermoplastic binding material on the glass fibers such that the thermoplastic binding material is at least partially melted. The heat source may be any element that heats, such as, but not limited to, a gas heater, hot air, a radio frequency apparatus, an ultrasonic energy apparatus, and a heat resistor. The heat from the heat source 76 is evenly and efficiently passed through the plates 56, 58 by the suction created through the vacuum box 60. Thus, it is not necessary for the heat source 76 to physically blow or force the heat or hot air into and through the compressed disc 74.

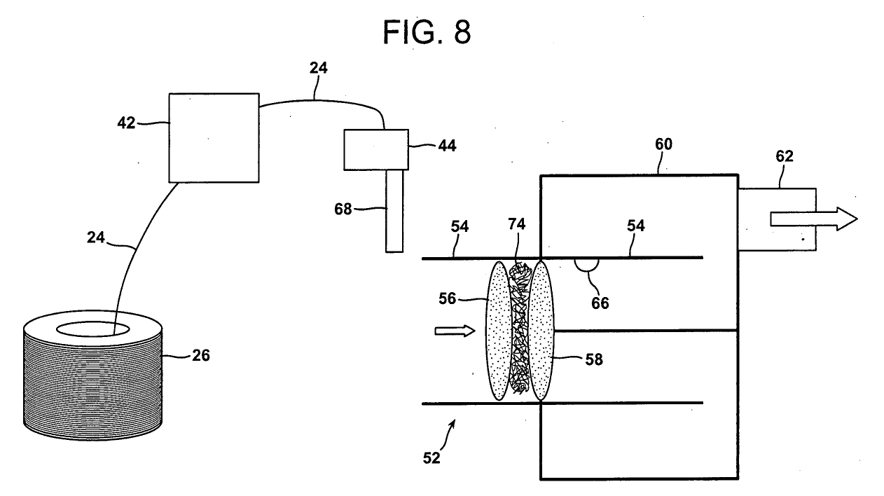

Once the thermoplastic material partially or completely achieves a molten state, the heat source 76 may be turned off and/or removed. The vacuum box 60, however, remains on to create suction to pull ambient air through the first and second perforated plates 56, 58, and disc 74. This passage of air through the disc 74 efficiently cools the thermoplastic material on the fibers and permits a rapid solidification of the thermoplastic material thus setting the compressed disc 74 into a disc-like preform. (See FIG. 8). The solidified thermoplastic material present at the cross-over points of the glass fibers 10 within the compressed disc 74 holds the glass fibers 10 into a compressed form (i.e., a preform product). It is also within the purview of the invention to pass cool air through the compressed disc 74 (not shown) to cool the thermoplastic size on the glass fibers 10. Because of the low melting temperatures of the thermoplastic materials, the cooling time for the product as well as the tooling is shorter than conventional thermoset performing processes.

The melting temperature depends on the specific thermoplastic material, and may melt at temperatures as low as 30° C. The amount of time necessary to achieve a temperature at which the glass fibers become bonded together is much shorter than the amount of time needed for a conventional thermoset binder to bond the fibers in a preform process. This reduction in heating time also equates to a shorter cooling time and overall reduced cycle time. For example, a cycle time of the instant invention may be 10 seconds compared to a cycle time of 22 minutes or more for conventional thermoset preform processes. Additionally, the uniform application of the thermoplastic sizing material on all of the surfaces of the glass fibers, achieved during the fiber manufacturing step, provides for a homogenous disc 74 (e.g., preform) and a consistent good part quality.

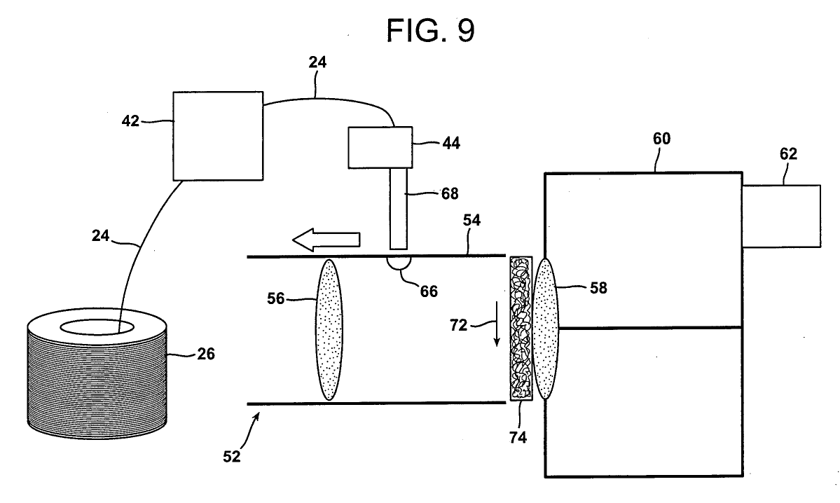

As represented in FIG. 9, the mold 52 is then withdrawn from the vacuum box 60 to allow the compressed disc 74 to be removed from the second perforated plate 58. The suction created in the vacuum box 60 holds the compressed disc 74 onto the second perforated plate 58 as the mold 52 disengages from the vacuum box 60. The mold 52 is moved a distance from the vacuum box 60 such that the wall 54 of the mold 52 does not touch the compressed disc 74. Once the mold 52 is completely disengaged from the vacuum box 60, the vacuum is turned off and the compressed disc 74 is permitted to fall away from perforated plate 58 in the direction of arrow 72 or be removed from the second perforated plate 58. The mold 52 is then repositioned into engagement with the vacuum box 60, as is reflected in FIG. 3, to permit the process to be repeated for the formation of another compressed disc or preform product. The removal of the compressed disc 74 from the mold 52 is clean and requires little or no maintenance. The compressed discs 74 may be stored for later use. Because of their small, compact shape, they are easily stored and shipped to consumers.

It is also considered within the purview of the invention to form a compressed preform product without the aid of suction, such as is created in a vacuum box. In such an embodiment, glass fiber strands may be texturized with the aid of a texturizing apparatus (e.g., a texturizing gun) and filled into a mold cavity or, alternatively, previously texturized fibers may be inserted into a mold cavity. The texturized fibers may then be compressed into a compressed preform that is subsequently heated and cooled. A mold may be heated in a manner in which heat permeates the mold, for example, by placing the mold into an oven. After the mold is permitted to cool, the compressed preform product is removed.

In an alternate embodiment described below, the thermoplastic material is applied to the glass fibers as they are introduced into the mold cavity and entangled by the air flow within the nozzle to form texturized glass fibers. In this embodiment, the thermoplastic material may be referred to as a “thermoplastic binder,” but may include the same materials and function in the same way as the thermoplastic materials described above. The thermoplastic binder and can be ionic, non-ionic, or ampohoteric in nature, and is preferably sprayed onto the continuous fibers that have previously been applied with a convention aqueous sizing and dried to achieve a texturized fiber that is encapsulated or nearly encapsulated with the thermoplastic material. The thermoplastic binder may be in molten state during application (e.g., spraying) or, alternatively, it may be in a solid state or in be present in an aqueous slurry that includes the thermoplastic material in a solid state. As discussed above, the even or substantially even coating of thermoplastic material on the glass fiber 78 provides for a homogenous end product.

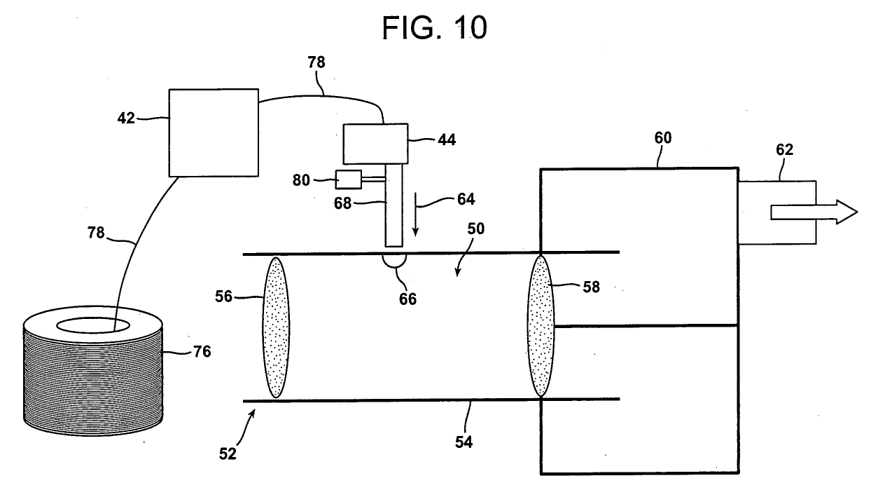

Turning to FIG. 10, a roving 76 supplies continuous sized glass fibers 78 to a feeder 42, which controls the speed or rate at which the continuous glass strands 24 are fed into the nozzle 44. The glass fibers 78 are preferably at least partially coated with any conventional aqueous sizing composition and are preferably in a dried form. The size composition applied to the glass fibers may include one or more film forming agents (such as a polyurethane film former, a polyester film former, a polyolefin film former, a modified functionalized polyolefin, an epoxy resin film former, or other thermoplastic or waxy substances), at least one lubricant, and at least one silane coupling agent (such as an aminosilane or methacryloxy silane coupling agent). When needed, a weak acid such as acetic acid, boric acid, metaboric acid, succinic acid, citric acid, formic acid, phosphoric acid, and/or polyacrylic acids may be added to the size composition, such as, for example, to assist in the hydrolysis of the silane coupling agent.

The conventional size composition further includes water to dissolve or disperse the active solids for application onto the glass fibers. Water may be added in an amount sufficient to dilute the aqueous sizing composition to a viscosity that is suitable for its application to glass fibers and to achieve the desired solids content on the fibers. In particular, the size composition may contain up to about 99% water. The size composition may be applied to the fibers with a Loss on Ignition (LOT) of from approximately 0.01-1.0% on the dried fiber.

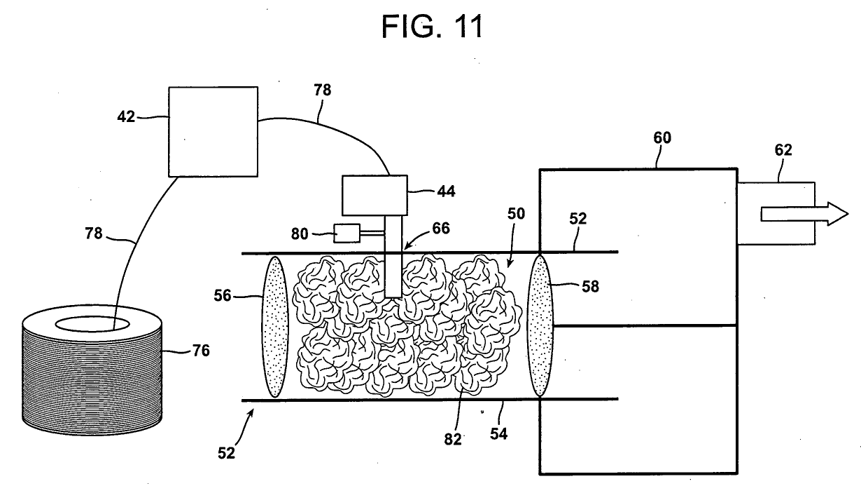

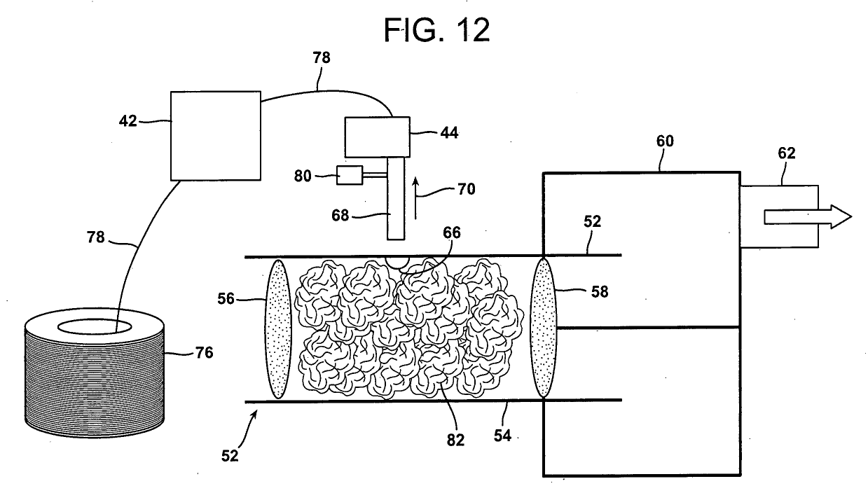

Once the neck 68 is in direct communication with the mold cavity 50 (see FIGS. 11 and 12). The nozzle 44 is moved downwardly in the direction of arrow 64 until the neck 68 of the nozzle 44 is inserted into the mold cavity 50 through an opening or orifice 66 in the wall 54 of the mold 52 to fill the mold cavity 50 with the continuous, sized glass fibers 78. As the nozzle 44 feeds the continuous glass fibers 78 into the mold cavity 50, an application device 80, such as an application gun, sprays the thermoplastic binder composition onto the glass fibers 78 as the compressed air within the nozzle 44 separates and entangles the glass fibers 78. The resulting texturized glass fibers 82 are at least partially coated with the thermoplastic binder composition. The texturized glass fibers 82 are then compressed, heated, cooled, as required, and removed from the mold as described in detail above with respect to FIGS. 6-9.

In at least one exemplary embodiment of the present invention, the compressed-disc 74 may be used as acoustic absorbing material in an engine exhaust muffler. One or more discs 74, depending on the size of the disc 74 and the size of the muffler, are randomly placed in the cavity of the muffler shell. It is to be appreciated that the compressed disc 74 may not necessarily have the shape of the muffler cavity. The compressed disc 74 may have exact or similar shape of the muffler cavity and may also be in a compressed form having similar shape of the muffler cavity. The compressed disc 74 thus provides for reduced complexity in the designing the preform shape. Upon heating the muffler, the compressed fibers within the disc 74 decompress and fill or nearly fill the muffler cavity. In particular, heating the thermoplastic material on the fibers melts and releases the fibers from their compressed or strained form. The glass fibers provide for good sound attenuation over the range of sounds emitted by an automobile engine. This reversible nature of the compressed disc 74 eliminates the need for a preform that has the precise and often complex dimensions of the muffler into which it is to be inserted. In addition, because the compressed disc(s) 74 are inserted into at least a partially finished muffler shell, there is no interference with the welding joints or overlap of the glass fibers outside of the muffler cavity. It is to be appreciated that the compressed disc 74 may be used in other embodiments that utilize texturized fibers as an inner component.

Further, the compressed disc 74 enables a lower part total weight. For example, typical muffler cavities are voluminous, and existing muffler preforms have the exact shape of the voluminous cavity (i.e., the existing preforms are not in a compressed form). To achieve good handleability of such voluminous preform shapes, more glass (e.g., 120-140 g/L) is required than is typically needed (i.e., approximately 80-100 g/L) to achieve optimum acoustic properties. On the other hand, in the present invention, the compressed disc 74 has an increased density (e.g., 600 g/L or higher) by the nature of it being compressed. As a result, an appropriate amount of glass is utilized to achieve a stable preform as well as optimum sound absorption, and the lower overall part weight is ideally achieved.

: Additionally, the thermoplastic material on the fibers allows a bad preform product (eg., a preform that that has not been properly compressed or has not been properly made due to a failure in any of the processing steps) to be converted into a usable preform part. Thus, the preform products formed by the inventive methods are recyclable. In particular, the texturized glass fibers forming the compressed disc, once they have been expanded to their “fluffy” texturized state by the addition of heat, may be re-compressed and re-molded into a compressed disc 74 due to the thermoplastic nature of the material. Thus, a preform product that has not been properly compressed may be re-compressed into a good preform product. Recycling the texturized glass fibers results in zero waste in the inventive method.

The method of the present invention provides numerous advantages over conventional methods of making preforms. For example, the process described herein is a simpler and a more compact process than conventional preform processes. The thermoplastic size composition is non-corrosive in nature, and, as a result, enhances the lifetime of the mold and enables the use of less expensive materials and mufflers. In addition, because the thermoplastic size compositions are non-hazardous substances, no special precautions need to be taken when handling or applying the thermoplastic size composition, unlike conventional phenolic binders. Due to the lack of additional chemicals in the inventive process, the inventive method is clean, dry, and environmentally friendly.

Having generally described this invention, a further understanding can be obtained by reference to certain specific examples illustrated below which are provided for purposes of illustration only and are not intended to be all inclusive or limiting unless otherwise specified.

### EXAMPLES

The examples set forth below are divided generally into fiber products having the inventive sizing composition applied thereto and preform parts made from the sized fibers using the inventive methods described herein. The quality of the fiber product was assessed by measuring the tex and LOI on the fiber products. The quality of the preform parts was assessed by measuring the density, dimensions, and dimensional stability (e.g., handling ability) of the preform parts.

### Example 1

### Formation of Fiber Product

Continuous glass fibers were applied with a non-aqueous sizing composition including an-ethoxylated fatty alcohol (ethoxylation with n=10-20 and a C₁₈ fatty alcohol) during the manufacturing (e.g. forming) of the glass fibers. The composition was composed of 98% by weight of the ethoxylated fatty alcohol and 2% by weight of an aminosilane. The sizing composition was used in a molten form and applied to the forming fibers in a continuous way using an applicator roll type apparatus. The fibers were gathered to form a strand and wound into a package as the sizing on the strand was permitted to cool and solidify. The total sizing composition was applied to the glass fibers at a level of 7% by weight of the fibers, and was measured by burning off the chemistry from the fiber strand. The wound fiber strand may be used to form a preform product.

### Example 2

### Formation of Fiber Product

A non-aqueous sizing composition based on a lower molecular weight modified polypropylene (i.e., a molecular weight of approximately 6500-7000) was applied to continuous glass fibers during their manufacturing. “Modified polypropylene” as used in this example is meant to indicate maleic anhydride functional moieties grafted onto polypropylene chains (e.g., Licocene 1332 available commercially from Clariant). The modified polypropylene (35% by weight) was then melt blended with micro waxes (65% by weight) in order to lower and adjust the processing and application viscosity. No silanes were utilized in the sizing composition. The composition was used in molten form and applied to the forming fibers in a continuous manner using an applicator roll type apparatus. The fibers were gathered to form a strand and then wound into a package as the sizing on the strand was permitted to cool and solidify. The total composition was applied to the glass fibers at a level of 7.10% by weight of fibers. The wound fiber strand may be used to form a preform product.

### Example 3

### Formation of Fiber Product

A non-aqueous sizing composition based on a lower molecular weight modified polypropylene (i.e., a molecular weight of approximately 4000) was applied to continuous glass fibers during their manufacturing. A “modified polypropylene” as used in this example is meant to indicate silane functional moieties grafted onto polypropylene chains (e.g., Licocene 3262 available commercially from Clariant). The modified polypropylene (40% by weight) was melt-mixed with 60% by weight of a wax, blends of waxes, micro waxes, or polyethylene waxes in order to adjust to the processing viscosity. No additional silane was utilized in the sizing composition. The composition was used in molten form and applied to the forming fibers in a continuous manner using an applicator roll type apparatus. The fibers were gathered to form a strand and then wound into a package as the sizing on the strand was permitted to cool and solidify. The total sizing composition was applied to the glass fibers at a level of 6.73% by weight of fibers. The wound fiber strand may be used to form a preform product.

### Example 4

### Formation of Fiber Product

A non-aqueous sizing composition based on a hyperbranched polyethylene wax (e.g., Vybar 260 available commercially from Beker Petrolite) was applied to continuous glass fibers during their manufacturing. The hyperbranched polyethylene wax (32.7% by weight) was melt blended with 65.3% by weight of a wax, blends of waxes, micro waxes, or polyethylene waxes in order to adjust to the processing viscosity. Additionally, 2% by weight of an aminosilane was added to the sizing composition. The composition was used in molten form and applied to the forming fibers in a continuous manner using an applicator roll type apparatus. The fibers were gathered to form a strand and wound into a package as the sizing on the strand was permitted to cool and solidify. The total composition was applied to the glass fibers at a level of 7% by weight of fibers. The wound fiber strand may be used to form a preform product.

### Example 5

### Formation of Fiber Product

A non-aqueous sizing composition based on a hyperbranched polyethylene wax (e.g., Polyboost 130 available commercially from S&S Chemicals) was applied to continuous glass fibers during their manufacturing. The hyperbranched polyethylene wax (32.7% by weight) was melt-mixed with 65.3% by weight of a wax, blends of waxes, or micro waxes in order to adjust to the processing viscosity. The composition was used in molten form and applied to the forming fibers in a continuous manner using an applicator roll type apparatus. The fibers were gathered to form a strand and then wound into a package as the sizing on the strand was permitted to cool and solidify. The total composition was applied to the glass fibers at a level of 6% by weight of fibers. The wound fiber strand may be used to form a preform product.

### Example 6

### Formation of Preform Product

A stable 30 g preform disk having a diameter of 65 mm was obtained using 2 strands of 3000 tex/7% by weight of the fibers of a thermoplastic coating input and texturized at 5 bar with a linear feed speed of 16 g/s (i.e., approx 1 kg/min). In this example, the 30 g of fibers was texturized into a mold having a volume of 330 ml. Compression enabled a preform product thickness reduction from 100 mm to 15 mm (i.e., a compression factor of 6.7). To obtain a proper setting of the fibers, the disc was heated with a hot air blower for 5 seconds at 130° C. while compression on the fibers was maintained. Room temperature air was allowed to be sucked through the preform for 5 seconds before removing the disc from the perforated plate. A vacuum of approximately 180 mbar (25 m/s) was applied during the entire process.

### Example 7

### Formation of Preform Product

A 30 g stable preform disc having a diameter of 65 mm was obtained using 2 strands of 3000 tex/7% by weight of the fibers of a thermoplastic coating was texturized at 5 bar at a linear line speed of 16 g/s (i.e., approximately 1 kg/min). In this example, the 30 g of fibers was texturized into a mold having a volume of 330 ml. Compression enabled a preform product thickness reduction from 100 mm to 15 mm (i.e., a compression factor of 6.7). To obtain a proper setting of the fibers using lower vacuum energy, a 60 mbar vacuum (10 m/s) was utilized. Heating the disc at 130° C. using a hot air blower appeared to be efficient to achieve a solid part after a minimum of 10 s. 10 seconds of cooling time by removing the heat source was necessary before the disc was removed from the mold (i.e., demolding).

### Example 8

### Formation of Preform Product

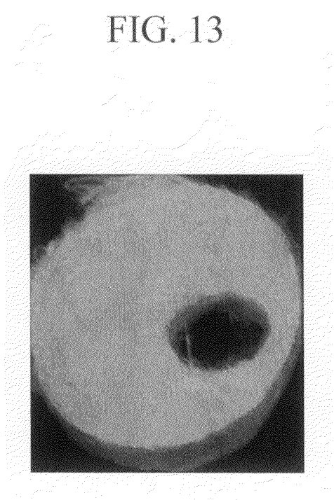

A stable 215 g elliptic preform having a diameter of 215 mm×165 mm was formed (see, e.g., FIG. 13) using 2 strands of 3000 tex/7% by weight of the fibers of a thermoplastic coating was texturized at 5 bar at a linear line speed of 16 g/s (i.e., approx 2 kg/min). The 215 g of fibers was texturized into a mold having a volume of 3 liters. Compression enabled a preform product thickness reduction from 130 mm to 18 mm (i.e., a compression factor 6.7). In order to obtain a proper setting of the fibers, a hot air blower was applied to the preform for 15 seconds at 130° C. to heat the preform while maintaining compression. A vacuum of 180 mbar was applied to achieve the lowest cycle time.

### Example 9

### Reversible Nature of Preform Product

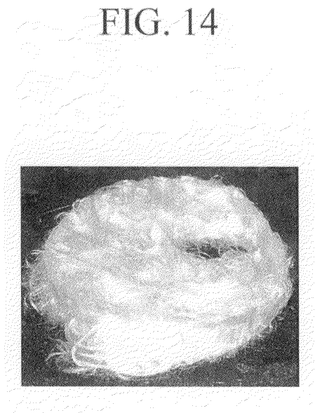

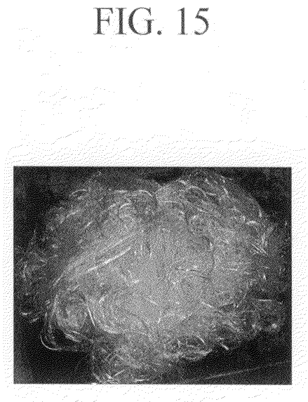

In order to demonstrate the reversibility, i.e., the ability of a compacted preform part formed in accordance with the inventive method and thermoplastic sizing composition to decompress or “fluff up” under heat, a compacted preform (shown in FIG. 13) was placed in a static oven at 80° C. The part was not moved, handled, touched, vibrated, or in any other way physically disturbed and was allowed heat in the oven. As shown in FIG. 14, after one minute in the 80° C. oven, the preform part began to loosen and regain a non-compact “fluffed” form. After 3 minutes, it can be seen that the preform part was completely decompressed (see FIG. 15). Thus, it can be concluded that the compacted preform part was decompressed (e.g., “fluffed up”) upon the application of heat. This heating simulates the heating of the preform part inside a muffler cavity, although in the muffler cavity, the temperatures will be much higher.

### Example 10

### Reduction of Waste

To demonstrate the reduction of waste that is achieved using the inventive method and inventive sizing composition, a compacted preform part formed in accordance with an exemplary method of the present invention was purposely destroyed by decompacting and pulling apart the preform part. The decompated, texturized strands were then placed into a mold cavity, heated, and cooled. The result was a newly formed compacted and usable preform part. Thus, the sized, texturized fibers can be re-used and re-compressed if an unacceptable part is formed, thereby reducing, or even eliminating, waste.

The foregoing description of the specific embodiments will so fully reveal the general nature of the invention that others can, by applying knowledge within the skill of the art (including the contents of the references cited herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The invention of this application has been described above both generically and with regard to specific embodiments.: Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A method of making a compressed preform product, comprising:
filling a mold cavity with continuous fibers at least partially coated with a thermoplastic sizing composition including a thermoplastic material;
compressing said continuous fibers;
heating said compressed continuous fibers to a temperature sufficient to at least partially melt said thermoplastic material on said continuous fibers; and
cooling said compressed continuous fibers to solidify said thermoplastic material on said continuous fibers to form a compressed preform product having a predetermined shape.

2. The method of making a compressed preform product according to claim 1, wherein said predetermined shape is independent of a shape of a cavity in which said compressed preform product is to be inserted.

3. The method of making a compressed preform product according to claim 1, further comprising:
applying said thermoplastic sizing composition to said continuous fibers during a fiber forming process for said continuous fibers to at least partially coat said thermoplastic sizing composition on said continuous fibers.

4. The method of making a compressed preform product according to claim 3, further comprising:
texturizing said continuous fibers by entangling said continuous fibers in a mold cavity to form continuous, texturized fibers.

5. The method of making a compressed preform product according to claim 4, wherein said texturizing and said filling occur simultaneously.

6. The method of making a compressed preform product according to claim 3, further comprising introducing a nozzle into said mold cavity to convey said continuous fibers into said mold cavity.

7. The method of making a compressed preform product according to claim 3, further comprising:
removing said cooled compressed preform product from said mold cavity.

8. The method of making a compressed preform product according to claim 3, wherein said removing step comprises:
applying suction to said compressed preform product to hold said compressed preform product onto a perforated plate affixed to a vacuum box and forming an end portion of a mold cavity positioned within a mold;
moving said mold a distance from compressed preform product; and
removing said suction, wherein when said suction is removed, said compressed preform product is released from said perforated plate.

9. The method of making a compressed preform product according to claim 1, further comprising:
applying said thermoplastic sizing composition to said continuous fibers as said continuous fibers are being filled into a mold cavity to at least partially coat said thermoplastic sizing composition on said continuous fibers.

10. The method of making a compressed preform product according to claim 9, further comprising:
applying an aqueous sizing composition to said continuous fibers prior to applying said thermoplastic sizing composition, said aqueous sizing composition being positioned on each of said continuous fibers between said continuous fiber and said thermoplastic sizing composition.

11. The method of making a compressed preform product according to claim 3, wherein said cooling comprises passing ambient air through said compressed preform product.

12. A method of making a fiber product for forming a preform comprising:
attenuating molten glass from a bushing to form glass fibers;
applying a thermoplastic sizing composition containing a thermoplastic material on said glass fibers under said bushing, said thermoplastic sizing composition substantially coating said glass fibers; and
cooling said thermoplastic material to solidify said thermoplastic material on said glass fibers and form a fiber product,
wherein said fiber product is capable of forming a preform without applying any additional sizing or binder compositions at later stages of a formation of said preform.

13. The method of claim 12, wherein said cooling step comprises:
permitting said coated glass fibers to air dry and solidify said thermoplastic material.

14. The method of claim 12, further comprising winding said fiber product into a roving.

15. A method of filling a muffler shell comprising:
filling a mold cavity with continuous, texturized fibers at least partially coated with a thermoplastic sizing composition including a thermoplastic material;
compressing said coated fibers within said mold cavity to form a compressed preform product;
heating said compressed preform product to a temperature sufficient to at least partially melt said thermoplastic material on said continuous fibers;
cooling said compressed preform product to solidify said thermoplastic material on said continuous fibers to form a compressed preform having a shape independent of a shape of a muffler cavity, said muffler cavity being internal to a muffler;
depositing one or more compressed preforms into said muffler cavity; and
decompressing said compressed preform by heating said muffler to a temperature sufficient to at least partially melt said thermoplastic material to reinstate said continuous, texturized fibers to a decompressed form and at least substantially fill said muffler cavity.

16. The method of clam 15, further comprising:
applying said thermoplastic sizing composition to said continuous fibers during a fiber forming process of said continuous fibers.

17. The method of claim 15, further comprising:
texturizing said continuous fibers by entangling said continuous fibers in a mold cavity to form said continuous, texturized fibers.

18. The method of claim 15, further comprising:
removing said cooled, compressed preform product from said mold cavity.

19. The method of claim 18, wherein said removing step comprises:
applying suction to said compressed preform product to hold said compressed preform product onto a perforated plate affixed to a vacuum box and forming an end portion of a mold cavity positioned within a mold;
moving said mold a distance from compressed preform product; and
removing said suction, wherein when said suction is removed, said compressed preform product is released from said perforated plate.

20. The method of claim 15, wherein said cooling step comprises:
permitting said thermoplastic binder material to air dry and solidify.
